(19) United States
(12) Patent Application Publication
(10) Pub. No.: US 2002/0079830 A1
(43) Pub. Date: Jun. 27, 2002

(54) Electroluminescent device comprising an electroluminescent material of at least two metal chelates

(75) Inventors: Klemens Brunner, Eindhoven (NL); Luisa De Cola, Amsterdam (NL); Johannes Willem Hofstraat, Eindhoven (NL)

Correspondence Address: Corporate Patent Counsel, U.S. Philips Corporation, 580 White Plains Road, Tarrytown, NY, 10591, US

(73) Assignee: Koninklijke Philips Electronics N.V.

(21) Appl. No.: 10/028,377

(22) Filed: Dec. 21, 2001

(30) Foreign Application Priority Data
Dec. 22, 2000 (EP) 00204738.9

(51) Int. Cl. H01J 63/04

(52) U.S. Cl. 313/498

(57) ABSTRACT

The invention pertains to an electroluminescent device comprising an electroluminescent material of at least two metal chelates, each metal chelate comprising a metal and chelating moieties, which metal chelates are connected to each other through a π-conjugated spacer or through a σ-conjugated spacer with enhanced through bond interaction. The electroluminescent material is used in LEDs and LECs.

The invention pertains to an electroluminescent device comprising an electroluminescent material of at least two metal chelates, particularly to Light Emitting Diodes (LEDs) and Light Emitting Cells (LECs). Further, the invention pertains to a method of generating electroluminescent light.

Organic electroluminescent (EL) devices are of great interest because of their efficient emission in the visible region and their application to full-color displays. Thus EL devices are reported which emit green or blue light, and also some red and orange emitting devices using polymers doped with organic complexes were reported. However, high performance devices based upon organic complexes have not yet been described. Up to now improvements have primarily been sought in the complexes as such. Thus various metals, often rare earth metals, were complexed to a variety of organic molecules, usually with heterocyclic structures. For instance, Okada et al., Synthetic Metals, 97, 113 (1998) disclosed that Eu complexes with β-diketone furan derivatives could be used to obtain bright red EL devices.

Further improvements were obtained by Wong and Chan, Adv. Mater., 11, 455 (1999), who described the light emitting properties of some ruthenium bipyridyl and terpyridyl derivatives in electroluminescent devices. They further disclosed that the incorporation of various Ru(II) polypyridine complexes into a conjugated polymer main chain can enhance the charge mobility of the resulting metal polymer complex. Wong and Chan therefore prepared Ru(II)-pyridine complexes that were attached to a conjugated main chain polymer through alkoxy spacers. However, although these complexes exhibit light emission in the yellow region and display relatively long lived metal-to-ligand charge transfer transitions, they have poor current-voltage characteristics, resulting in a high voltage threshold value for emitting light and a faint voltage-current slope. Because of these disadvantages, these complexes are not really useful for practical applications in EL devices.

EL devices have increasing importance, particularly for use in automotive displays and in displays for mobile phones and for other portable devices, such as personal digital assistants and laptop computers. Such EL devices are used, for instance as LEDs or LECs in displays for portable equipment and for computers. Other applications are LEDs or LECs in warning and pilot lamps, signal lights, remote control systems, diagnostic devices, lasers, optocouplers, waveguides, and the like.

The present invention is aimed at obtaining metal polymer complexes with high charge mobility, low voltage threshold values, and steep voltage-current slopes. To this end the electroluminescent device of this invention is characterized in that it comprises an electroluminescent material of at least two metal chelates, each metal chelate comprising a metal and chelating moieties, which metal chelates are connected to each other through a π-conjugated spacer or through a σ-conjugated spacer providing enhanced through bond interaction.

In a preferred embodiment of the electroluminescent device each of the metals is independently selected from Ru, Rh, Os, Zn, Cr, Pt, Pd, Ir, Cu, and the rare earth metals, and the chelating moieties are selected from substituted or unsubstituted: or a moiety of the general formula:

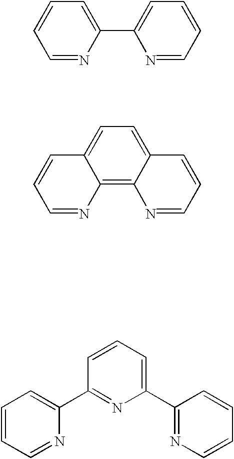

or a moiety of the general formula:

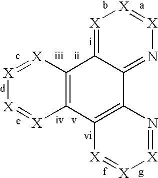

wherein X is independently CH or N, preferably at least one of the groups X being N, and the bonds a, b, c, d, e, f, and g, and the combination of bonds i/ii/iii and iv/v/vi are optionally condensed with a benzene group or a condensed aromatic moiety, wherein aromatic carbon atoms may be replaced by nitrogen atoms and wherein the complexing moiety may be substituted with C₁₋₆ alkyl, C₂₋₆ alkenyl, C₂₋₆ alkynyl, C₃₋₄ alkylene, CN, halogen, COOH, C₁₋₃ alkyl-COOH, NO₂, NH₂, or a pending group for further functionalization or complexation. More preferred are the complexes wherein two of the groups X are N.

At least one of the chelating moieties of each of the metal chelates is covalently bonded to the π-conjugated spacer or through a σ-conjugated spacer with enhanced through bond interaction, which preferably is an oligo- or polymeric unit comprising substituted or unsubstituted phenylenevinylene, vinylcarbazol, fluorene, phenylenethyne, phenylene, thiophene, acetylene, and/or pyrrol moieties.

The metals are preferably selected from Ru(II), Rh(I), Os(II), Zn(II), Cr(III), Pt, Pd, Ir(III), Cu(I), and the rare earth metals, and are more particularly Ru(II) or Zn(II).

The chelating moieties can be unsubstituted or independently substituted by a substituent selected from halogen, hydroxy, unsubstituted or alkyl-substituted amino, nitrile, alkyl ether, branched or unbranched alkyl and/or alkenyl, nitro, trialkylphosphino, unsubstituted and substituted phenyl, carboxyl, carboxyl ester, carbamide, sulfonate, polyphenylenevinylene, polyvinylcarbazol, polyfluorene, polythiophene, polyacetylene, polypyrrol, polyphenylene and poly(p-phenylene ethynylene) groups.

The term halogen means a member of the group of fluorine, chlorine, bromine, and iodine.

The terms alkyl and alkenyl in the above definitions mean alkyl and alkenyl groups with 1 to 8 carbon atoms, which groups may be branched. Examples are methyl, ethyl, isopropyl, ethenyl, 1,3-butadienyl, and the like.

The esters in the above definitions are the common esters, like alkyl, aryl, and aralkyl esters. Examples are methyl, ethyl, phenyl, and benzyl esters. Were the phenyl group in the above definition is substituted, these substituents are the common substituents for aromatic groups, such as alkyl, alkoxy, halogenide, amino, and nitro groups, and the like.

Particularly useful are electroluminescent devices wherein the metal is Ru(II) or Zn(II), the chelating moiety is 2,2′-bipyridyl, and the spacer is poly(1,4-phenylene).

The electroluminescent device may contain more than two metal chelates. A useful electroluminescent material that may contain more than two metal chelates is:

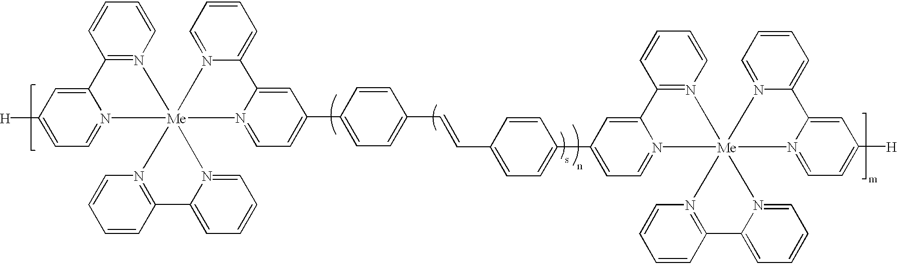

wherein Me is Ku(II) or Zn(II), n=1-15, m=1-100, and s=0 or 1. Preferably Me is Ru(II), n=3-6, m=1, and s=0.

Some of the above mentioned metal polymer complexes are known per se. For instance, Schlicke et al., J. Am. Chem. Soc., 121, 4207 (1999) disclosed the synthesis of compounds wherein two ruthenium and osmium bipyridine complexes are connected to each other through a 1,4-phenylene spacer, which publication is incorporated by reference. The other metal polymer complexes of the invention can be prepared by similar methods, which are standard methods for the man skilled in the art.

The invention also pertains to electroluminescent devices such as a LED or LEC. LEDs and LECs are devices that make use of the electroluminescent phenomenon and that emit light when suitably connected to a power supply. The electroluminescent material of the invention is preferably contained in a layer of an electrically conducting or semiconducting polymer or matrix, or covalently bonded or doped with said polymer. LEDs are made as layered structures, usually with a substrate, a transparent electrode, an electroluminescent material-containing layer, and a second electrode. Additional layers may be applied to improve the electronic properties of the device. The structure of such LEDs is known in the art and described in many publications that belong to the standard knowledge of the artisan.

In another aspect the invention pertains to a method of generating electroluminescent light by applying a voltage to two electrodes that are separated form each other by one or more layers, at least one of which comprises the previously described electroluminescent material.

The invention is further illustrated by the following example.

### EXAMPLE

Synthesis of (bpy)₂Rubpy-ph₄-bpyRU(bpy)₂

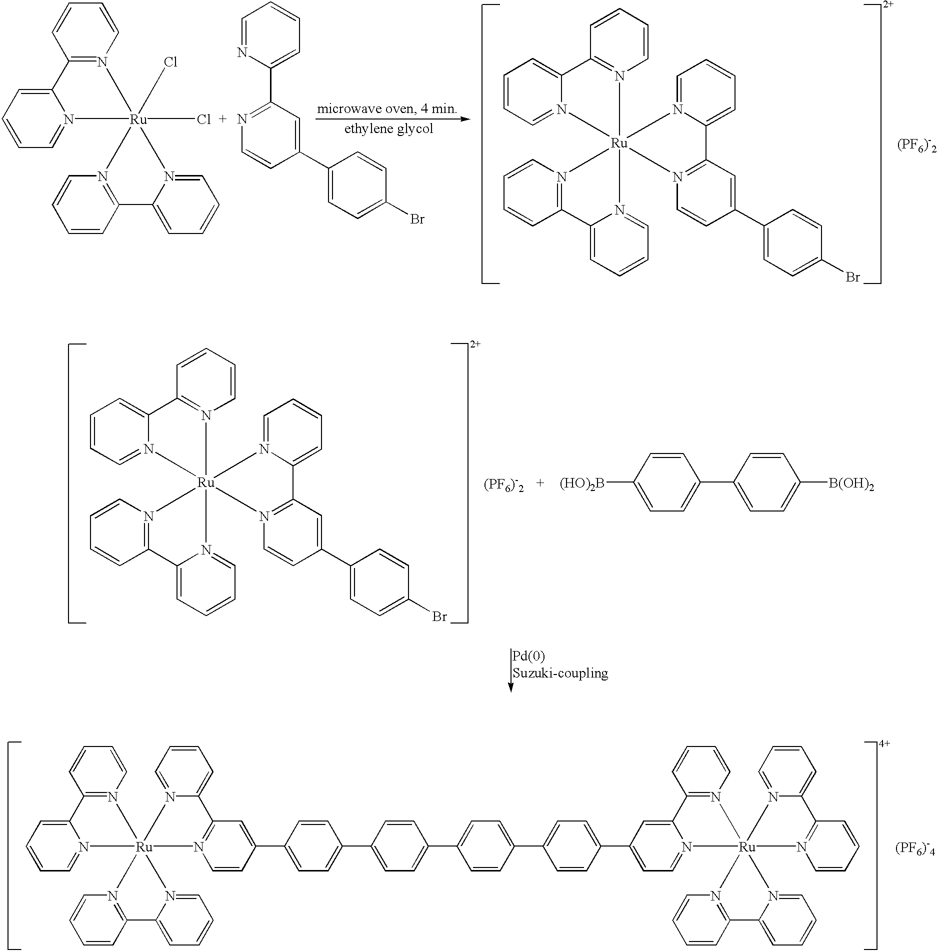

Coordination of the bromophenyl-bipyridine ligand to Ru(bpy)₂Cl₂ in the microwave oven during 2×2 minutes, using ethylene glycol as solvent. Second step:

Coupling of two Ru compounds with 4,4′-biphenyldiboronic acid via a Suzuki-coupling reaction, using Pd(PPh₃)₄ as catalyst in ethanol/dioxane (1:1) with K₂CO₃ as base.

The ruthenium dimer with (PF₆)⁻ as counterion is soluble in acetonitrile and acetone. With BARF as counterion the metal complexe is soluble in ether, dichloromethane and toluene.

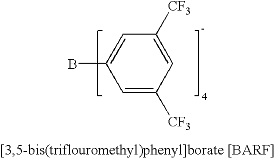

Procedure for Preparation of an Electroluminescent Device:

A standard LED was prepared using the above electroluminescent complex as the guest in a green-emitting polyphenylenevinylene copolymer of formula A1 as the host. A green emissive layer was chosen as the host for the (bpy)₂Rubpy-ph₄-bpyRu(bpy)₂ complex synthesized above.

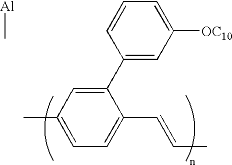

All the steps were done under controlled atmosphere (N₂) in a glovebox.

The preparation of the device comprised the following steps:

A. Preparation of the polymer solution:

90 mg of a para-phenylenevinylene copolymer were dissolved in 30 ml of dichloromethane. The solution was stirred for ˜24 hours at 28-30° C.

B. Preparation of the Ru solution:

8 mg of the Ru dimer (PF₆) were dissolved in 200 μL of acetonitrile. Stirring for ˜24 hours at 28-30° C.

C. Preparation of the mixture polymer/Ru dimer:

10 ml of the polymer/dichloromethane solution were mixed with 200 μL of Ru dimer/acetonitrile. The mixture was stirred at 33° C. for 1 hour.

D. Spincoating on glass/ITO:

To get a polymer-layer with a thickness of 60-70 nm the solution was spun at 1200 r/min (10 s), followed by 300 r/min (25s). Acceleration of 200 ms.

E. Depositon of Ba/Al on the polymer layer:

Deposition rate for barium: 0.3 nm/s

Deposition rate for aluminium: 0.5 nm/s

Properties of the Electroluminescent Device:

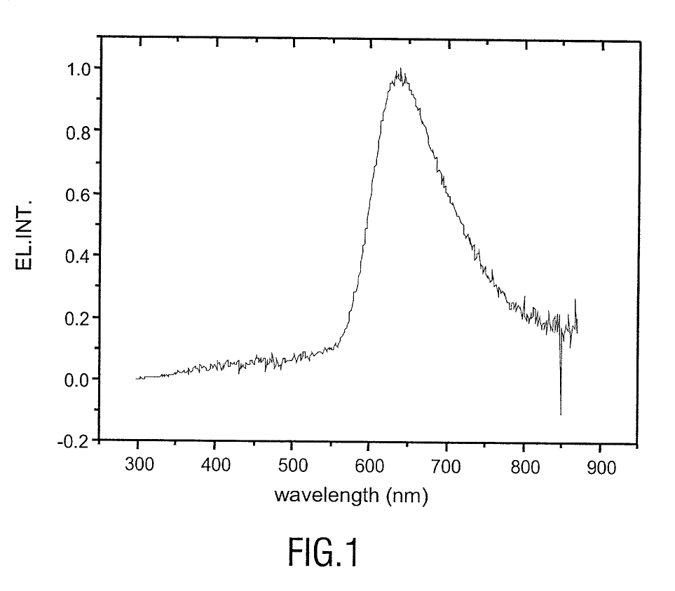

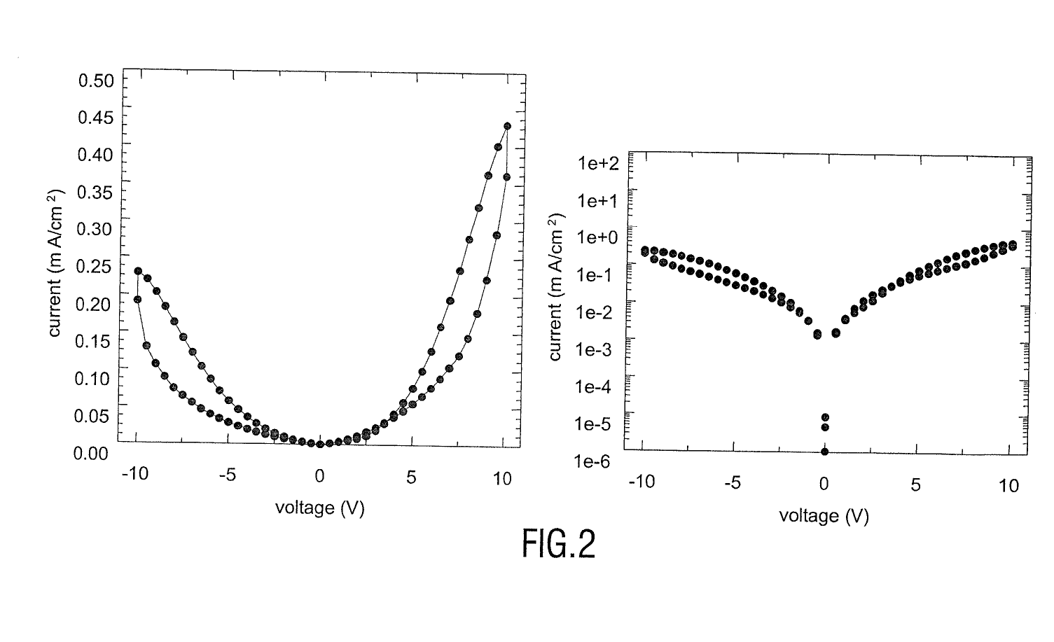

The thus prepared device showed strong electroluminescence. In FIG. 1 the electroluminescent spectrum of the based device is displayed, showing strong emission intensity obtained on application of a voltage to the device. In FIG. 2 the I-V (current-voltage) curve of a voltage sweep cycle of the thus prepared device is shown. From this figure the low voltage threshold (0.5 V) and the steep current-voltage slope of this bi-nuclear Ru metal-complex is apparent.

Further Example

Using a procedure analogous to the previous example a range of further EL devices in accordance with the invention are manufactured having the following general structure: anode/EL layer/cathode.

ITO (indium tin oxide, 140 nm, >20 Ω/) acts as the transparent anode and aluminium (thickness 100 nm) is the cathode.

The EL layer consists of (100−x) wt % of the green semiconducting polyphenylene vinylene polymer A1 in which x wt % of the bikemel complex used in the previous example is dispersed and x=20, 30 or 50.

Obviously, the particular choice of anode, cathode and semiconducting polymer is not essential but merely used as an example to illustrate the invention.

### COMPARATIVE EXAMPLE

### (Not in Accordance with the Invention)

A similar range of exemplary devices is manufactured with the difference that the bikemel complex is replaced with a monokernel complex comprising a single Ru chelate of formula A2.

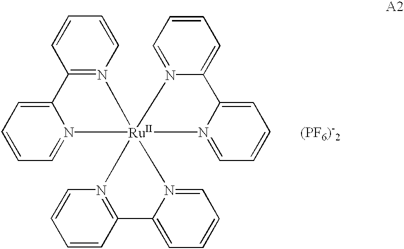

The amount of monokernel complex is selected such the number of Ru nuclei in the EL layer is the same as that of the corresponding bikernel EL layers described in the previous example. Accordingly, the monokernel devices are referred to as the x=20, 30 or 50 monokernel devices.

The range of bikernel and monokernel complex containing EL devices so manufactured are then each in turn connected to a power source (anode to +ve terminal and cathode to −ve terminal) and a suitable voltage applied to achieve light emission.

All three bikernel EL devices (x=20, 30 and 50), are found to emit a similar red-colored light. Comparison with the luminescence spectrum of pure (x=100) bikernel complex shows that the red-colored light emission originates from the bikernel complex.

In contrast, of the monokernel EL devices only the x=50 device emits such red light, the x=20 and x=30 monokernel EL devices emitting green light characteristic of the green emitting PPV polymer. However, the amount of red light emitted by the x=50 monokernel EL device is about one order of magnitude less than the corresponding x=50 bikernel EL device.

The I-V (current-voltage) relationship of the range of bikernel and monokernel complex containing EL devices so manufactured is then measured.

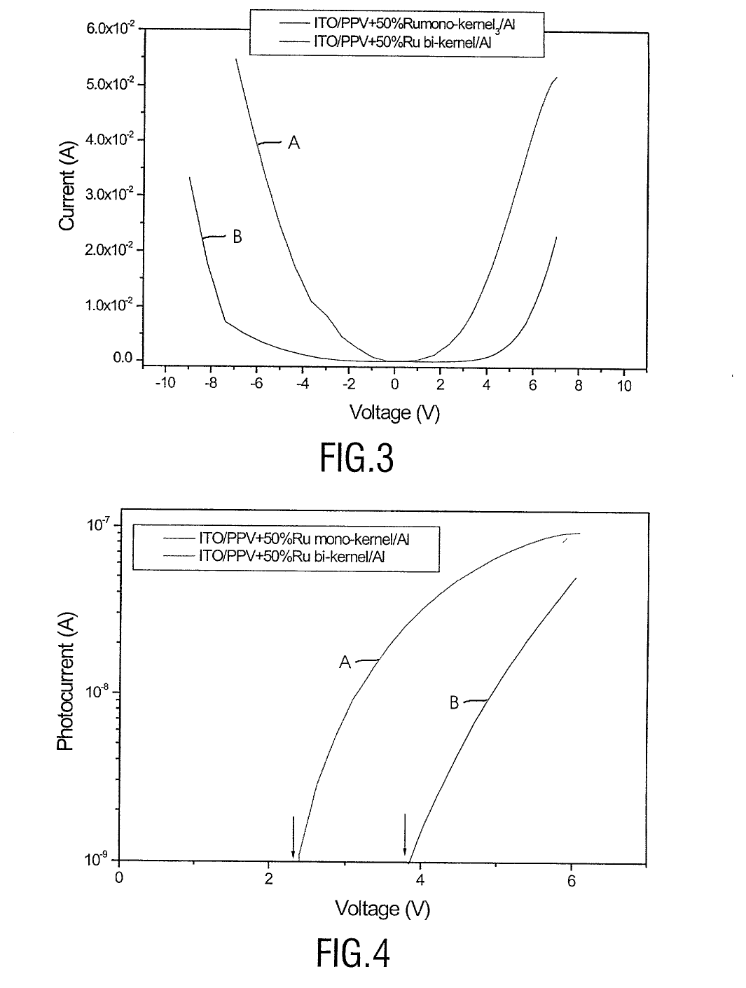

FIG. 3 shows the I-V relationship of a bikernel EL device (curve A) in accordance with the invention and a monokernel EL device (curve B) not in accordance with the invention. In particular, curve A corresponds to the x=50 bikernel device and curve B to the x=50 monokernel device.

FIG. 3 shows that, in accordance with the invention, the bikernel device is, at the same voltage, capable of supporting significantly higher currents. This is of particular advantage in time-multiplexed matrix-addressed EL devices.

Similar results are obtained for the x=20 and 30 bikernel versus monokernel devices.

FIG. 4 shows the photocurrent (in A) as a function of voltage (in Volts) of a bikernel EL device in accordance with the invention (curve A) and a monokernel EL device not in accordance with the invention (curve B). In particular, curve A corresponds to the x=50 bikernel device and curve B to the x=50 monokernel device. The photocurrent is a measure of the amount of light emitted by the EL device.

FIG. 4 shows that, in accordance with the invention, the threshold voltage at which light emission occurs is significantly lower for the bikemel EL device (just over 2 V) compared to the monokernel device (about 4 V).

Similar results are obtained for the x=20 and x=30 EL devices.

1. An electroluminescent device comprising an electroluminescent material of at least two metal chelates, each metal chelate comprising a metal and chelating moieties, which metal chelates are connected to each other through π-conjugated spacer or through a σ-conjugated spacer with enhanced through bond interaction.

2. The electroluminescent device of claim 1 wherein each of the metals is independently selected from Ru, Rh, Os, Zn, Cr, Pd, Pt, Ir, Cu, and the rare earth metals, the chelating moieties are selected from substituted or unsubstituted: 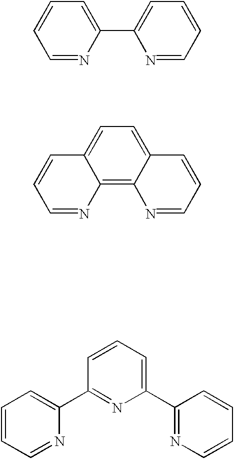
or a moiety of the general formula: 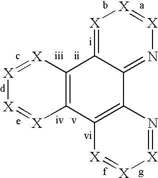
wherein X is independently CH or N, preferably at least one of the groups X being N, and the bonds a, b, c, d, e, f, and g, and the combination of bonds i/ii/iii and iv/iv/vi are optionally condensed with a benzene group or a condensed aromatic moiety, wherein aromatic carbon atoms may be replaced by nitrogen atoms and wherein the complexing moiety may be substituted with C₁₋₆ alkyl, C₂₋₆ alkenyl, C₂₋₆ alkynyl, C₃₋₄ alkylene, CN, halogen, COOH, C₁₋₃ alkyl-COOH, NO₂, NH₂, or a pending group for further functionalization or complexation;
and wherein at least one of the chelating moieties of each of the metal chelates is covalently bonded to the π-conjugated spacer or to the σ-conjugated spacer with enhanced through bond interaction.

3. The electroluminescent device of claim 2, wherein the spacer is an oligo- or polymeric unit comprising substituted or unsubsitituted phenylenevinylene, vinylcarbazol, fluorene, phenylenethyne, phenylene, thiophene, acetylene, and/or pyrrol moieties.

4. The electroluminescent device of any one of claims 1-3 wherein the metal is selected from Ru(II), Rh(I), Os(II), Zn(II), Cr(III), Pt, Pd, Ir(III), Cu(I), and the rare earth metals, and more particularly from Ru(II) and Zn(H).

5. The electroluminescent device of any one of claims 1-4 wherein the chelating moieties are unsubstituted or independently substituted by a substituent selected from a halogen, hydroxy, unsubstituted or alkyl substituted amino, nitrile, alkyl ether, branched or unbranched alkyl and/or alkenyl, nitro, trialkylphosphino, unsubstituted and substituted phenyl, carboxyl, carboxyl ester, carbamide, sulfonate, polyphenylenevinylene, polyvinylcarbazol, polyfluorene, polyphenylene, polythiophene, polyacetylene, polypyrrol, and poly(p-phenylene ethynylene) group.

6. The electroluminescent device of any one of claims 1-5 wherein the metal is Ru(II) or Zn(II), the chelating moiety is 2,2′-bipyridyl, and the spacer is polyphenylene.

7. The electroluminescent device of any one of claims 1-6 wherein the electroluminescent material is: 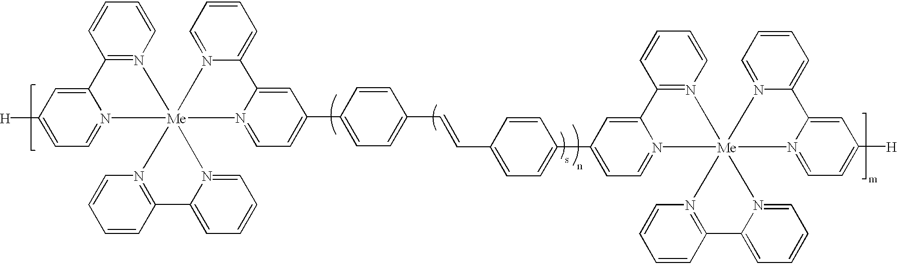
Me is Ru(II) or Zn(II), n=1-15, m=1-100, and s=0 or 1.

8. The electroluminescent device of claim 7 wherein Me is Ru(II), n=3-6, m=1, and s=0.

9. The electroluminescent device of any one of the preceding claims wherein the device is a LED or LEC.

10. A method of generating electroluminescent light by applying a voltage to two electrodes that are separated form each other by one or more layers, of which at least one comprises the electroluminescent material of any one of claims 1-8.
